(19) United States
(12) Patent Application Publication
(10) Pub. No.: US 2003/0063959 A1
(43) Pub. Date: Apr. 3, 2003

(54) Expansion screw

(76) Inventor: Sha-Lan Kao, Taoyuan City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 09/968,025

(22) Filed: Oct. 2, 2001

(51) Int. Cl. F16B 1/00

(52) U.S. Cl. 411/60.2

(57) ABSTRACT

An expansion screw includes an expansion sleeve having a conical plug assembled to an expandable front part thereof, a locating sleeve screwed to a rear part of the expansion sleeve, and a screw adapted to screw into the locating sleeve. The expansion sleeve includes an annular retaining groove between the expandable front part and the rear part thereof for receiving an O-ring therein. The O-ring is provided along its circumference with a plurality of claws that catch threads at the most front end of the screw to firmly hold the screw to the expansion sleeve. Therefore, the screw would not rotate and thereby loosen or separate from the locating and the expansion sleeves due to vibration caused by any external force, ensuring a secure and safe fastening of an item via the expansion screw.

### BACKGROUND OF THE INVENTION

An expansion screw is frequently used to fasten or hold something to a building structure, particularly to a wall. A conventional expansion screw A is shown in FIG. 1 and mainly includes a screw A1, a sleeve A2, and a conical plug A3. The screw A1 is screwed into a rear part of the sleeve A2 and the conical plug A3 is plugged into a front opening of an expandable front part of the sleeve A2. When the sleeve A2 is forced into the wall, the conical plug A3 in front of the sleeve A2 is stopped by the wall and the sleeve A2 is gradually pushed toward the conical plug A3 to expand its expandable front part along a conical wall of the conical plug A3. The expanded sleeve A2 is therefore tightly pressed against the wall surrounding it and firmly held to the wall.

While the sleeve A2 is firmly forced into the wall to tightly contact with the latter at the expanded front part, the screw Al screwed into the sleeve A2 tends to gradually rotate relative to and loosen from the sleeve A2 and eventually separate therefrom due to vibrating forces constantly acted on the building.

That is, while the expandable sleeve A2 keeps tight contact with the wall, the screw A1 might have become loosened from the sleeve A2 and no longer effectively holds the previously fastened item to the wall. There is great latent danger in the conventional expansion screw endangering the safety of persons in and surrounding the building.

### SUMMARY OF THE INVENTION

It is therefore a primary object of the present invention to provide an improved expansion screw that includes components more securely connected to one another to ensure firm and safe fastening of any item to the building structure via the expansion screw and accordingly, the safety of people's life and properties.

To achieve the above and other objects, the expansion screw of the present invention includes an expansion sleeve having a conical plug assembled to an expandable front part thereof, a locating sleeve screwed to a rear part of the expansion sleeve, and a screw adapted to screw into the locating sleeve. The expansion sleeve includes an annular retaining groove between the expandable front part and the rear part thereof for receiving an O-ring therein. The O-ring is provided along its circumference with a plurality of claws that catch threads at the most front end of the screw to firmly hold the screw to the expansion sleeve. Therefore, the screw would not rotate and thereby loosen or separate from the locating and the expansion sleeves due to vibration caused by any external force, ensuring a secure and safe fastening of an item to, for example, a wall via the expansion screw.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is an exploded perspective view of a conventional expansion screw;

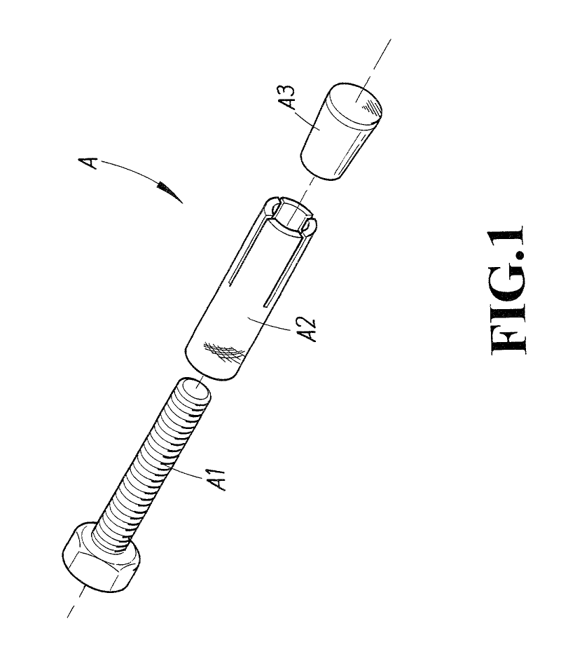

FIG. 2 is an exploded perspective view of an expansion screw according to a preferred embodiment of the present invention;

FIG. 3 is an assembled sectional view of the expansion screw of FIG. 2; and

FIG. 4 is a fragmentary, assembled sectional view of an expansion screw according to another embodiment of the present invention.

### DETAILED DESCRIPTION OF THE PREFERRED EMBODIMENTS

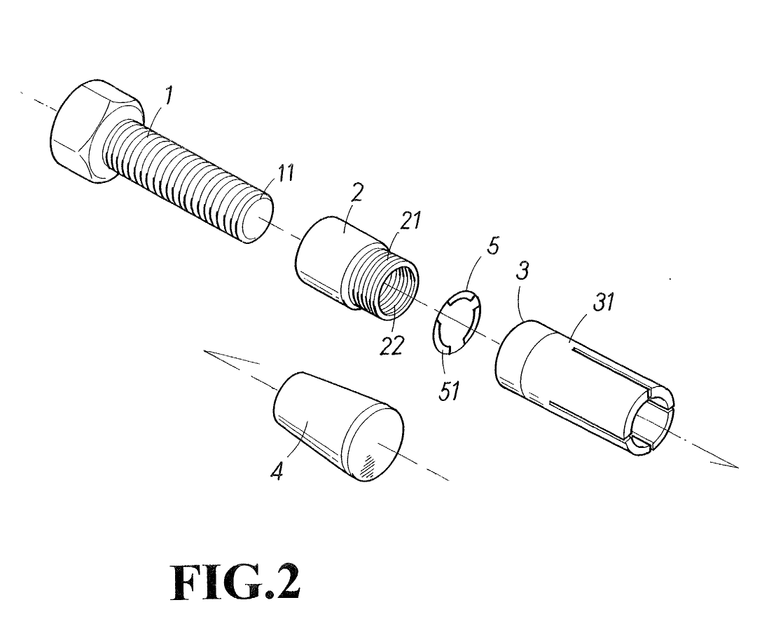

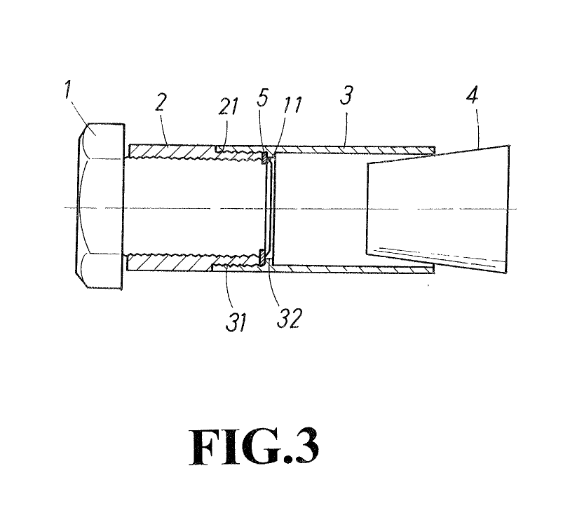

Please refer to FIGS. 2 and 3, in which an expansion screw according to a preferred embodiment of the present invention is shown. The expansion screw of the present invention mainly includes a screw 1, a locating sleeve 2, an expansion sleeve 3, a conical plug 4, and an O-ring 5.

The screw 1 is a general standard screw element having screw threads 11 provided around a shank of the screw 1.

The locating sleeve 2 includes a front part provided with external threads 21 and an inner wall surface provided with internal threads 22 for engaging with the threads 11 of the screw 1.

The expansion sleeve 3 includes a front part that is radially outward expandable, and a rear part that is internally provided with threads 31 for engaging with the external threads 21 at the front part of the locating sleeve 2, so that the locating sleeve 2 is connected to a rear end of the expansion sleeve 3. An annular retaining groove 32 is formed inside the expansion sleeve 3 between the expandable front part and the internally threaded rear part.

The conical plug 4 is a commercially available element for an expansion screw and has been assembled to a front opening of the expandable front part of the expansion sleeve 3.

The O-ring 5 is provided along its circumference with a plurality of claws 51 and is pre-positioned in the annular retaining groove 32 in the expansion sleeve 3.

The locating sleeve 2 is connected to the rear part of the expansion sleeve 3 by engaging the external threads 21 with the internal threads 31 so that the O-ring 5 fixedly located in the retaining groove 32 between the locating sleeve 2 and the expandable front part of the expansion sleeve 3 together with the connected locating and expansion sleeves 2, 3 to provide a semi-assembly of the expansion screw ready for use.

To use the expansion screw of the present invention, first force the semi-assembly of the expansion screw into a pilot hole (not shown) pre-formed on a wall. When the expansion sleeve 3 is forced against the conical plug 4 that is an element located at the most front of the semi-assembly of the expansion screw the expandable front part of the expansion sleeve 3 is radially expanded to tightly press against the wall surrounding it and thereby securely holds the semi-assembly of the expansion screw to the wall. And then thread the screw 1 into the locating sleeve 2 via a rear opening thereof to engage the threads 11 of the screw 1 with the internal threads 22 of the locating sleeve 2 to fasten a desired item to the wall with the expansion screw. When the screw 1 is fully threaded into the locating sleeve 2, threads 11 that are located at the most front end of the shank of the screw 1 are tightly caught by the claws 51 on the O-ring 5, enabling the screw 1 to firmly and stably connect to the expansion sleeve 3. The engagement of the threads 11 with the claws 51 of the O-ring 5 protects the screw 1 from undesired rotation and loosening relative to the expansion sleeve 3 and the locating sleeve 2 when the whole expansion screw of the present invention in the wall is subject to vibration due to external forces. That is, the whole expansion screw is able to maintain a firmly assembled structure without the risk of a loosened or even separated screw 1 from the locating sleeve 2 and the expansion sleeve 3 of the expansion screw.

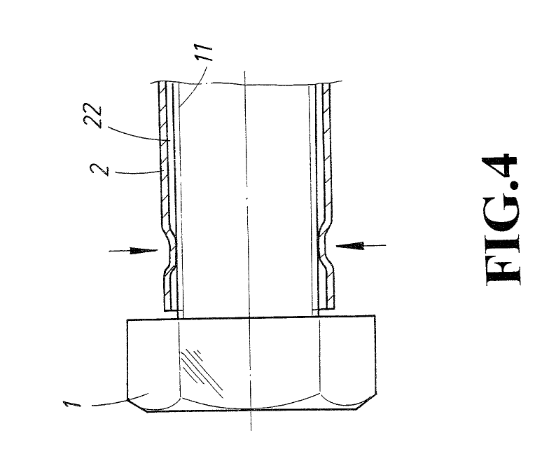

FIG. 4 shows an expansion screw according to another embodiment of the present invention. In this embodiment, the locating sleeve 2 is locally deformed at a predetermined position with an external force, so as to produce, for example, an annular depression that directly applies a tight pressure on the screw 1 threaded into the locating sleeve 2 and thereby firmly holds the screw 1 in place in the locating sleeve 2. The pressure applied on the screw 1 by the annular depression on the locating sleeve 2 is large enough to prevent the screw 1 from rotating relative to or loosening from the locating sleeve 2 when the whole expansion screw on the wall is subject to any vibration. The expansion screw of the present invention is therefore structurally safe for use.

What is claimed is:

1. An expansion screw, comprising:
a screw meeting a standard screw specification;
a locating sleeve including a front part provided with external threads and an inner wall surface provided with internal threads for engaging with external threads provided around a shank of said screw;
an expansion sleeve including a front part that is radially outward expandable, a rear part that is internally provided with threads for engaging with said external threads at the front part of said locating sleeve, and an annular retaining groove formed inside said expansion sleeve between said expandable front part and said internally threaded rear part;
a conical plug being assembled to a front opening of said expandable front part of said expansion sleeve; and
an O-ring having a plurality of claws provided along a circumference thereof, and said O-ring being positioned in said annular retaining groove in said expansion sleeve;
whereby when said screw is fully threaded into said locating sleeve, said external threads of said screw located at a most front end thereof are caught by said claws on said O-ring, enabling a firm and stable connection of said screw to said locating sleeve and said expansion sleeve and thereby protecting said screw from rotating or loosening relative to said locating sleeve and said expansion sleeve due to any vibration caused by external forces.

2. The expansion screw as claimed in claim 1, wherein said locating sleeve is locally deformed at a predetermined position to produce at least a radial depression that applies a tight pressure on said screw threaded into said locating sleeve and thereby firmly holds said screw in place in said locating sleeve, preventing said screw from loosening or separating from said locating sleeve due to any vibration.
